(19) United States
(12) Patent Application Publication
(10) Pub. No.: US 2008/0110532 A1
(43) Pub. Date: May 15, 2008

(54) Method and Means for Oxygen Cutting of Cast Strands and Steel Workpieces in or Downstream of Continuous Steel Casting Plants

(76) Inventor: Horst K. Lotz, Hauterive/NE (CH)

Correspondence Address: THE WEBB LAW FIRM, P.C., 700 KOPPERS BUILDING, 436 SEVENTH AVENUE, PITTSBURGH, PA, 15219, US

(21) Appl. No.: 11/929,355

(22) Filed: Oct. 30, 2007

(30) Foreign Application Priority Data
Oct. 30, 2006 (DE) 10 2006 051 043.7

(51) Int. Cl. B23K 7/00

(52) U.S. Cl. 148/195; 266/50

(57) ABSTRACT

In a method and means for oxygen cutting of cast strands and steel workpieces or downstream of continuous casting plants, by means of a membrane (9) controlled pressure measuring and regulating valve (1) with pressure and flow converters (16, 17, 18) on the basis of predetermined reference values, supply of a cutting nozzle of a cutting torch with heating gas and heating oxygen for generation of an optimum cutting flame is electrically and/or electronically adjusted, readjusted or shut down and/or predetermined maximum deviations from the reference values are recognized, indicated and used for signalling or cutting torch shutdown. A time-consuming regulation of the cutting flame of the cutting torch is avoided as a result penitent variable delivery of heating gas and heating oxygen to the cutting torch.

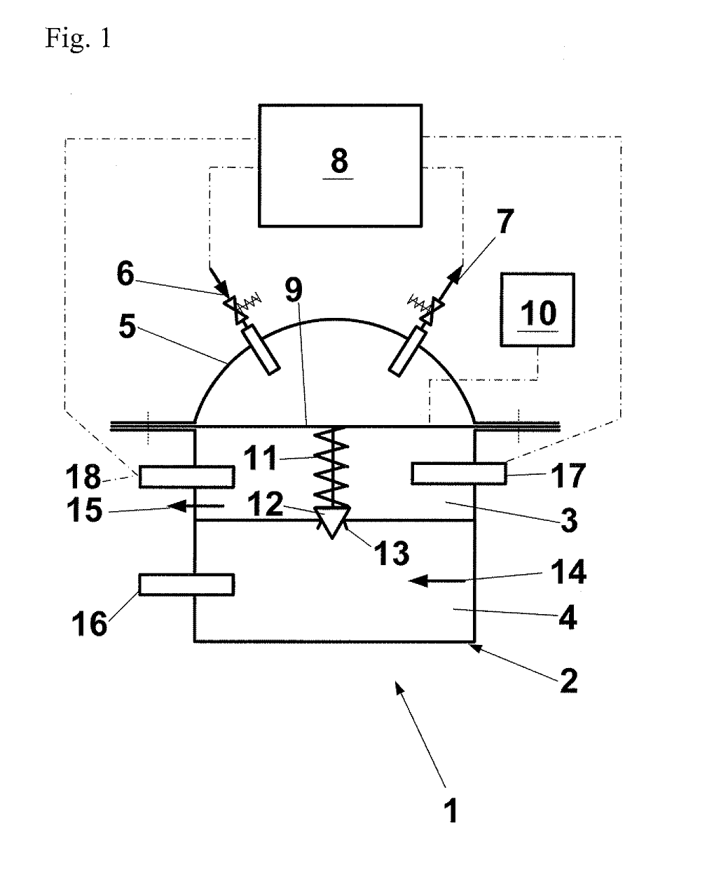

The invention relates to a method and means for safe and economical oxygen cutting of cast strands and steel workpieces in cold and hot condition in or downstream of continuous steel casting plants for blooms and slabs.

For further processing into lengths corresponding to the final products and which are portable, continuously cast steel strands must be subdivided in continuous casting plants. These mainly hot slabs and blooms are usually separated by oxygen cutting torches on an oxygen cutting machine. On such an oxygen cutting machine an oxygen cutting stream and/or cutting flame transforms the steel brought to ignition temperature into a discharging oxide slag thus creating a joint growing into a cut during movement. The cutting machine design is especially destined for flame cutting of round, square and rectangular shapes with diameters and sections up to approx. 350 mm.

In order to control pressure and flow of the heating gas and the heating oxygen for the cutting torch, pressure reducers are used. The pressure reducer is only adjusted once and after such adjustment operates always with the same gas flow and the same gas pressure. But often it will be necessary that different gas pressures and gas flows are required for flame cutting depending on the type of the workpiece to be cut (bloom or slab)or the steel grade.

The cutting nozzle required for the flame cutting process is built into the cutting torch. After cutting torch ignition, the cutting machine operating personnel will visually evaluate the cutting flame according to its experience and, if necessary, readjusts delivery, i.e. heating gas and/or heating oxygen flow and pressure. This is very time-consuming and often results in qualitatively insufficient cutting areas on the cast strand and/or workpiece, hereinafter only called workpiece.

It is the object of the present invention to create a method and means of the type mentioned above avoiding time-consuming regulation of the cutting flame of the cutting torch and permitting variable delivery of heating gas and heating oxygen to the cutting torch.

In accordance with the procedure the object is solved by electrically and/or electronically adjusting, readjusting or switching off supply of a cutting nozzle of a cutting torch with heating gas and heating oxygen for producing an optimum cutting flame by means of a membrane-controlled pressure measuring and regulating valve with pressure and flow converters on the basis of predetermined reference values and/or by recognising, indicating predetermined maximum deviations from the reference values and using them for signalling or cutting torch shutdown, with the membrane being charged by inlet and outlet valves in a valve dome with a compressed gas for influencing gas flow and gas pressure so that an opening between an upper valve chamber in which the pressure converter and the flow converter is arranged and the lower valve chamber in which the pressure converter is arranged opens and closes dependent on the membrane motion. Normally natural gas, propane gas, coke gas or acetylene is used as a heating gas for the cutting torch.

By this method an optimum adjustment of the cutting flame of the cutting torch's cutting nozzle is achieved. The time-consuming and sometimes faulty readjustment of the heating gas and heating oxygen flow and pressure can be omitted, since this occurs by the membrane-controlled pressure measuring and regulating valve with pressure and flow converters on the basis of predetermined reference values. Thus adjustment of an optimum cutting flame of the cutting torch is automated. Moreover, due to optimum adjustment of the cutting torch, large quantities of heating gas and heating oxygen can be saved.

Further characteristics and advantages of the invention result from the dependent claims.

Preferably, for rapid but stepwise modification of flow and pressure, a compressed gas is supplied to and discharged from the membrane-controlled pressure measuring and regulating valve via the membrane until the pressure and flow converters report the reference values achieved or their deviations to an electric and/or electronic control system. The control system processes, on the basis of predetermined reference values, comparative values and adjustment values or measured values for controlling the variation of gas supply and discharge, for state detection and information. This action as well results in an automatic adjustment of an optimum cutting flame of the cutting torch.

Moreover, the cutting nozzle of the cutting torch to be used in each case is provided with a specification for the respective nozzle insert created by a calibration process. This specification is adopted prior to or with the nozzle insert to be integrated into the cutting torch by the electric and/or electronic control system as a comparative, reference or initial value by means of coding.

Thus already the manufacturer of the flame cutting machine can, for example by means of a calibrator, on the basis of predetermined reference values, electrically and/or electronically determine, adjust and regulate supply of a cutting nozzle of a cutting torch with the required pressure and heating gas and heating oxygen quantity for generation of an optimum cutting flame. The reference values are passed on to the user of the flame cutting machine and/or transmitted directly to the cutting torch.

Accordingly, in particular a bar code is preferably used and created as a coding for the comparative, reference or initial value for adjustment of the optimum cutting flame for the nozzle insert of the cutting torch. The operator of the flame cutting machine can read in the bar code, in which the reference value for adjustment of the cutting flame is stored, by means of a scanner and the electric and/or electronic control system can automatically adjust the bar code on the nozzle insert.

The objective is realised in accordance with the invention also by a means of the type mentioned above, namely by a membrane-controlled pressure measuring and pressure regulating valve with a valve body having an upper and a lower valve chamber, and with valve dome, a spring-loaded push rod and with pressure and flow converters associated with a control system with the membrane on the valve dome being charged with a compressed gas for influencing gas flow and gas pressure for rapid but stepwise modification of the gas flow quantity and gas pressure by a pair of solenoid valves or a proportional valve associated with the control system, with the pressure converter and flow converter being arranged in the upper valve chamber and the pressure converter being arranged in the lower valve chamber. Heating gas and heating oxygen are used as a gas here.

This device has the same advantages and effectiveness as have been described above for the inventive method. This device permits variable supply of the cutting torch with heating gas and heating oxygen. In this connection it is also important that instead of usual statically adjustable pressure reducers, controllable pressure and flow converters are used for the cutting torch.

Moreover it is provided that the pair of solenoid valves or the proportional valve is associated with an electric and/or electronic control system, processing comparative and adjustment or measured values on the basis of predetermined reference values for controlling variation of supply and discharge of the gas, for state detection and state information.

Moreover it is important that each one membrane-controlled pressure measuring and pressure regulating valve for heating gas and heating oxygen have to be provided for generating an optimum cutting flame on the cutting torch.

It is self-evident that the above mentioned characteristics and the characteristics still to be explained can be used not only in the combination specified but also in other combinations or alone without abandoning the scope of the present invention.

The inventive idea is described in detail by means of the following embodiment illustrated in the drawing. The figure of the drawing is a schematic view of a membrane-controlled pressure measuring and pressure regulating valve for a means for safe and economical oxygen cutting of cast strands and workpieces out of steel in cold and hot condition in or downstream of continuous steel casting plants for billets, blooms and slabs.

The pressure measuring and pressure regulating valve 1 for heating gas and heating oxygen comprises a valve body 2 with an upper valve chamber 3 and a lower valve chamber 4. Moreover, a cupola-like valve dome 5 is placed onto the valve body 2. It has an inlet valve 6 and an outlet valve 7, which are associated with an electric and/or electronic control system 8 and are formed as a solenoid valve or as a proportional valve.

Between the upper valve chamber 3 and the valve dome 5 a membrane 9 is arranged, which is connected to a pre-controller 10 modifying the membrane deflection of the pressure measuring and pressure regulating valve 1. For stepwise variation of gas flow and gas pressure, membrane 9 is charged with a compressed gas for influencing gas flow and gas pressure through the inlet valve 6 and the outlet valve 7 on valve dome 5.

A valve push rod 12 charged with a compression spring 11 rests on membrane 9 opening and closing an opening 13 between the upper valve chamber 3 and the lower valve chamber 4 of valve body 2 depending on the motion of the membrane 9 with gas flowing into the lower valve chamber 4 according to arrow 14 and gas discharging at the upper valve chamber 3 according to arrow 15.

In the lower valve chamber 4 a pressure converter 16 and at the upper valve chamber 3 a pressure converter 17 and a flow converter 18 are arranged which are connected to the control system 8.

By means of the pressure measuring and pressure regulating valve 1 a gas flow according to a predetermined reference value of flow pressure and thus also of flow quantity is controlled and regulated via gas inlet 14 and gas outlet 15 resp. The reference value is generated by inflow of a gas flow with higher pressure via the inlet valve 6 or outflow of the existing gas via the outlet valve 7 for generation of a lower pressure via membrane 9.

The differential pressure above and below membrane 9 varies in co-operation with compression spring 11 the opening 13 for modification of the gas flow passing through so that the gas flow desired is discharged at the gas outlet 15 with the desired pressure. The pressure converters 16, 17 and the flow converter 18 convert the gas pressures and gas quantities detected into electric signals, which are transmitted to the control system 8, permitting comparison with the adjustment values stored in the control system, from which control signals for opening and closing of the inlet valve 6 and the outlet valve 7 on valve dome 5 of the pressure measuring and pressure regulating valve 1 are then delivered.

### LIST OF REFERENCE NUMERALS

1 pressure measuring and pressure regulating valve
2 valve body
3 upper valve chamber
4 lower valve chamber
5 valve dome
6 inlet valve (solenoid valve)
7 outlet valve (solenoid valve)
8 control system
9 membrane
10 pre-controller
11 compression spring
12 valve push rod
13 opening

14 gas inlet
15 gas outlet
16 pressure converter
17 pressure converter
18 low converter

1. A method for safe and economical oxygen cutting of cast strands and steel workpieces in cold and hot conditions in or downstream of continuous casting plants for blooms and slabs, wherein by means of a membrane-controlled pressure measuring and regulating valve having a first and second pressure converter and flow converter on the basis of predetermined reference values, supply of a cutting nozzle of a cutting torch with heating gas and heating oxygen for generation of an optimum cutting flame is electrically or electronically adjusted, readjusted or shut down and optionally, predetermined maximum deviations from the reference values are recognized, indicated, and used for signalling or cutting torch shutdown, wherein the membrane of the membrane-controlled pressure measure and regulating valve is charged by inlet and outlet valves in a valve dome with a compressed gas for influencing gas flow and gas pressure such that an opening between an upper valve chamber in which the second pressure converter and the flow converter is arranged and a lower valve chamber in which the first pressure converter is arranged, opens and closes dependent on the motion of the membrane.

2. The method according to claim 1, wherein for rapid but stepwise modification of flow and pressure, a compressed gas is supplied to and discharged from membrane-controlled pressure measuring and regulating valve via the membrane until the first and second pressure converters and flow converter are configured to report the reference values achieved or their deviations to an electronic control system, configured to process on the basis of predetermined reference values, comparative values and adjustment values or measured values for controlling the variation of gas supply and discharge, for state detection and information.

3. The method according to claim 2, wherein the cutting nozzle of the cutting torch is provided with a specification for the respective nozzle insert created by a calibration process with the specification being adopted prior to or with the nozzle insert to be integrated into the cutting torch by the electronic control system as a comparative, reference or initial value by means of coding.

4. The method according to claim 3, wherein a bar code is created as a coding for the comparative, reference or initial value for adjustment of the optimum cutting flame for the nozzle insert of the cutting torch.

5. The method according to claim 4, wherein the coding for optimum cutting flame adjustment for the cutting torch is configured to be read by a scanner and is automatically adjusted on the nozzle insert by the electronic control system.

6. The method according to claim 1, wherein natural gas, propane gas, coke gas or acetylene is used as a heating gas for the cutting torch.

7. Means for safe and economical oxygen cutting of cast strands and steel workpieces in cold and hot condition in or downstream of continuous casting plants for billets, blooms and slabs, comprising :
a membrane-controlled pressure measuring and pressure regulating valve; having
a valve body having an upper and a lower valve chamber;
a valve dome;
a spring-loaded push rod; and
a first and second pressure converter and a flow converter associated with a control system, wherein the membrane of the membrane-controlled pressure measuring and pressure regulating valve on the valve dome is charged with a compressed gas for influencing gas flow and gas pressure for rapid but stepwise modification of the gas flow quantity and gas pressure by a pair of solenoid valves or a proportional valve associated with the control system, wherein the second pressure converter and flow converter are arranged in the upper valve chamber and the first pressure converter is arranged in the lower valve chamber.

8. The means according to claim 7, wherein the control system is electric or electronic and is configured to process comparative and adjustment or measured values on the basis of predetermined reference values for controlling variation of supply and discharge of the gas, for state detection and state information.

9. The means according to claim 7, wherein the membrane-controlled pressure measuring and pressure regulating valve for heating gas and heating oxygen is configured to generate an optimum cutting flame on the cutting torch.
